(19) United States
(12) Patent Application Publication
(10) Pub. No.: US 2026/0227152 A1
(43) Pub. Date: Aug. 6, 2026

(54) DOT SIGHT

(71) Applicant: ZHUHAI MEFO OPTICAL INSTRUMENTS CO., LTD., Zhuhai (CN)

(72) Inventors: Hui YANG, Zhuhai (CN); Yinquan HE, Zhuhai (CN); Dayun LIN, Zhuhai (CN); Xiping YU, Zhuhai (CN)

(73) Assignee: ZHUHAI MEFO OPTICAL INSTRUMENTS CO., LTD., Zhuhai (CN)

(21) Appl. No.: 19/577,439

(22) Filed: Mar. 25, 2026

Related U.S. Application Data
(63) Continuation of application No. PCT/CN2025/081956, filed on Mar. 11, 2025.

(30) Foreign Application Priority Data
Dec. 5, 2024 (CN) 202411783341.0

(51) Int. Cl. F41G 1/30

(52) U.S. Cl. CPC F41G 1/30

(57) ABSTRACT

Provided is a dot sight. The dot sight includes a sight body, a first lens, a light source mechanism, and a battery mechanism, where the sight body is provided with a bottom and a side wall; and the bottom and the side wall enclose an optical channel open at two ends. During mounting, the bottom of the sight body is connected to a firearm body or a connecting base plate, and the light source mechanism and the battery mechanism are disposed on the side wall of the sight body except the bottom. This renders the bottom a small thickness, which is not larger than the height of centers of a rear sight and a front sight after the sight is mounted. Thus, the bottom of the sight avoids obstructing the mechanical sight mechanism, allowing the shooter to see the front sight through the optical channel on the sight body.

### CROSS-REFERENCE TO THE RELATED APPLICATIONS

This application is a continuation application of International Application No. PCT/CN2025/081956, filed on March 11, 2025, which is based upon and claims priority to Chinese Patent Application No. 202411783341.0, filed on December 5, 2024, the entire contents of which are incorporated herein by reference.

### TECHNICAL FIELD

The present disclosure belongs to the technical field of sights, and particularly relates to a dot sight.

### BACKGROUND

Pistols, due to their light weight, portability, and ability to accurately hit targets within a certain range, are among the best choices for shooters in scenarios such as field hunting and target shooting. To improve the shooting accuracy, most pistols on the market are provided with a mechanical sight mechanism to facilitate target aiming by shooters.

For example, the Chinese Patent Application No. CN217403266U discloses a red dot sight with easy ballistic adjustment. On the one hand, the optical channel of the sight body is sealed by a reflective lens and a transparent barrier plate to prevent rainwater from entering the optical channel and avoid the impact of water accumulation on light transmission. On the other hand, the ballistic adjusting bolt is disposed on the top of the sight body to prevent the adjustment tool from obstructing the field of view during ballistic adjustment, thereby facilitating the shooter's operation. For another example, the Chinese Patent Application No. CN214701937U discloses a sealed sight. To minimize the impact of moisture and foreign matter in the environment on the sight, the technical solution of this patent places the light source in a sealed environment and fills the sealed environment with nitrogen to protect the light source, thereby endowing the sight with high stability. The Chinese Patent Application No. CN117537662A discloses an optical sight. The optical sight is sealed by passing a connecting assembly through an access hole for airtight mounting in a mounting hole and mounting a sealing assembly in the access hole, and is connected to a firearm. Compared with the prior art, by mounting the optical sight on the firearm, this mounting method reduces the mounting difficulty of the optical sight and thus improves its mounting efficiency. In addition, the sealing of the optical sight via the connecting assembly and the sealing assembly prevents foreign matter from entering the gap between the two lenses of the optical sight. This not only improves the cleanliness of the lenses of the optical sight but also improves the user experience of the optical sight.

However, most existing optical sights are mounted between the rear sight and the front sight of the mechanical sight mechanism, and the sight base is often higher than the centers of the rear sight and the front sight. Consequently, the mechanical sight mechanism is partially or even completely obstructed. In the event of failure, damage, or other inoperability of the optical sight, the shooter cannot aim at the target by using the mechanical sight mechanism of the firearm, which severely impairs the user experience of shooters.

### SUMMARY

An objective of the present disclosure is to provide a dot sight, aiming to solve the technical problem that a sight in the prior art obstructs the mechanical sight mechanism of a pistol after being mounted, thereby compromising the user experience.

The present disclosure is implemented as follows. A dot sight includes a sight body, a first lens, a light source mechanism, and a battery mechanism, where the sight body includes a bottom and a side wall; the bottom and the side wall enclose an optical channel; the first lens is disposed in the optical channel; the light source mechanism is disposed on the side wall, and is configured to emit light to the first lens so as to provide an aiming reference for a user; the battery mechanism is disposed on the side wall, and is configured to be electrically connected to the light source mechanism so as to supply power to the light source mechanism; the bottom of the sight body is connected to a firearm body through a fastener; and a thickness of the bottom is less than or equal to 2.5 mm, allowing the user to observe a front sight through a rear sight and the optical channel after the sight body is mounted.

In an optional embodiment, a connecting base plate is disposed between the bottom of the sight body and the firearm body; the connecting base plate is connected to the firearm body through the fastener; and the bottom of the sight body is connected to the connecting base plate and the firearm body through the fastener.

In an optional embodiment, the fastener is fixed by a fastening tool; and the side wall is provided with an access structure configured to provide access for the fastening tool.

In an optional embodiment, the side wall includes a top surface portion and a side surface portion; the top surface portion is disposed opposite to and at an interval from the bottom; the side surface portion is connected between the top surface portion and the bottom; the access structure includes a first access hole disposed in the top surface portion; and a position of the first access hole corresponds to a position of the fastener.

In an optional embodiment, the access structure further includes a second access hole; and the second access hole is disposed in the side surface portion of the side wall.

In an optional embodiment, the first access hole is provided with a sealing member; and the sealing member is configured to seal the first access hole when the sight body is in operation.

In an optional embodiment, the bottom is provided with a drain hole; and the drain hole is configured to discharge accumulated water in the optical channel to an exterior of the sight body.

In an optional embodiment, the side wall includes a top surface portion and a side surface portion; the top surface portion is disposed opposite to and at an interval from the bottom; the side surface portion is connected between the top surface portion and the bottom; the access structure includes a second access hole disposed in the side surface portion; and a position of the second access hole is matched with a position of the fastener.

In an optional embodiment, the light source mechanism includes a light-emitting source, a mounting base, a ballistic adjustment mechanism, and a windage adjustment mechanism; the mounting base is movably disposed on the sight body; the light-emitting source is disposed on the mounting base; the ballistic adjustment mechanism is disposed on the sight body, and is configured to adjust a position of the mounting base along a first direction; the windage adjustment mechanism is disposed on the sight body, and is configured to adjust a position of the mounting base along a second direction; and an angle is formed between the first direction and the second direction.

In an optional embodiment, the ballistic adjustment mechanism includes a ballistic slider, a ballistic driving portion, and a first biasing assembly; the ballistic slider is slidably disposed on the sight body; at least part of the ballistic slider abuts against the mounting base; the ballistic driving portion is disposed on the sight body, and is configured to drive the ballistic slider to move along the first direction; the first biasing assembly is disposed between the sight body and the mounting base; and the first biasing assembly is configured to apply a force to the mounting base toward the ballistic slider such that the mounting base keeps abutting against the ballistic slider.

In an optional embodiment, the ballistic driving portion includes a ballistic adjusting bolt; the ballistic adjusting bolt is rotatably disposed on the sight body; an axis of the ballistic adjusting bolt is disposed along the first direction; the ballistic adjusting bolt has a degree of freedom to rotate around an axis thereof relative to the sight body; and at least part of the ballistic adjusting bolt is threadedly connected to at least part of the ballistic slider.

In an optional embodiment, the windage adjustment mechanism includes a windage slider, a windage driving portion, and a second biasing assembly; the windage slider is slidably disposed on the sight body; the windage driving portion is disposed on the sight body, and is configured to drive the windage slider to move along the second direction; the second biasing assembly is disposed between the sight body and the mounting base; the windage slider and the second biasing assembly respectively abut against two sides of the mounting base along the second direction; and the second biasing assembly is configured to apply a force to the mounting base toward the windage slider.

In an optional embodiment, the windage driving portion includes a windage adjusting bolt; the windage adjusting bolt is rotatably disposed on the sight body; an axis of the windage adjusting bolt is disposed along the second direction; the windage adjusting bolt has a degree of freedom to rotate around an axis thereof relative to the sight body; and at least part of the windage adjusting bolt is threadedly connected to at least part of the windage slider.

In an optional embodiment, the dot sight further includes a second lens; and the second lens is disposed at an interval from the first lens along a length direction of the optical channel.

In an optional embodiment, a periphery of the first lens is hermetically connected to the sight body, and a periphery of the second lens is also hermetically connected to the sight body; and the first lens, the second lens, and an inner wall surface of at least part of the optical channel enclose a sealed chamber.

In an optional embodiment, the connecting base plate is provided with a threaded hole engaging with the fastener; the threaded hole is located at a side of the second lens away from the first lens, and is disposed at an interval from the second lens; and a minimum distance between an inner wall of the threaded hole and a side surface of the second lens away from the first lens is 2-5 mm.

In an optional embodiment, the side wall is further provided with a power receiving assembly; the power receiving assembly is electrically connected to the battery mechanism; and the power receiving assembly is configured to receive electric energy output by a wireless power supply terminal so as to charge the battery mechanism.

In an optional embodiment, the connecting base plate is provided with an engagement structure; and the engagement structure is configured to position a mounting position of the sight body on the connecting base plate.

In an optional embodiment,

the engagement structure includes engagement posts; the bottom of the sight body is provided with engagement holes engaging with the engagement posts; there are at least two engagement posts; the engagement holes are matched with the engagement posts in quantity; and the connecting base plate is provided with at least two threaded holes configured to be connected to the sight body;

alternatively, the engagement structure includes engagement posts; the bottom of the sight body is provided with engagement holes engaging with the engagement posts; there are at least two engagement posts; the engagement holes are matched with the engagement posts in quantity; and the connecting base plate is provided with one threaded hole configured to be connected to the sight body;

alternatively, the engagement structure includes an engagement member; the bottom of the sight body is provided with an engagement groove engaging with the engagement member; and the connecting base plate is provided with at least two threaded holes configured to be connected to the sight body; and

alternatively, the engagement structure includes an engagement member; the bottom of the sight body is provided with an engagement groove engaging with the engagement member; and the connecting base plate is provided with one threaded hole configured to be connected to the sight body.

Compared with the prior art, the present disclosure has the following technical effects. The bottom and the side wall of the sight body enclose the optical channel, the first lens is disposed in the optical channel, and the light source mechanism and the battery mechanism are disposed on the side wall of the sight body. The battery mechanism supplies electric energy to the light source mechanism, such that the light source mechanism can emit light to irradiate the first lens, and the first lens can process and reflect the light to form a specific aiming mark for aiming. Meanwhile, the bottom of the sight body is connected to the firearm body through a fastener, and the thickness of the bottom is less than or equal to 2.5 mm, such that the user can observe the front sight through the rear sight and the optical channel after the sight body is mounted. Compared with the sight in the prior art, during mounting, the bottom of the sight body is connected to the firearm body or the connecting base plate, and the light source mechanism and the battery mechanism are disposed on the side wall of the sight body except the bottom, such that the bottom can have a small thickness. The thickness of the bottom is less than or equal to 2.5 mm, which is lower than the height of a mechanical sight channel on the firearm. The thickness of the bottom of the sight body is not larger than the height of the centers of the rear sight and the front sight after the sight is mounted, thereby preventing the bottom of the sight from obstructing the mechanical sight mechanism. Thus, after the sight body is mounted, the user can observe the front sight through the rear sight and the optical channel. Thus, even when the sight fails, the shooter can still aim at a target through the mechanical sight mechanism on the firearm body, such that the pistol can still maintain accuracy even when the sight fails, and the secure mounting of the sight is also ensured.

### BRIEF DESCRIPTION OF THE DRAWINGS

To describe the technical solutions in the embodiments of the disclosure more clearly, the following briefly introduces the drawings required for describing the embodiments of the present disclosure or the prior art. Apparently, the drawings in the following description show merely some embodiments of the present disclosure, and those of ordinary skill in the art may still derive other drawings from these drawings without creative efforts.

FIG. 1 is a structural schematic diagram of a pistol in the prior art;

FIG. 2 is a structural schematic diagram of a sight mounted on the pistol in the prior art;

FIG. 3 is a side view of a sight mounted on the pistol in the prior art;

FIG. 4 is a structural schematic diagram of a dot sight in a mounted state according to an embodiment of the present disclosure;

FIG. 5 is a first structural schematic diagram of a dot sight according to an embodiment of the present disclosure;

FIG. 6 is a second structural schematic diagram of the dot sight according to an embodiment of the present disclosure;

FIG. 7 is an exploded view of the dot sight according to an embodiment of the present disclosure;

FIG. 8 is an enlarged view A shown in FIG. 7;

FIG. 9 is a first side view of a dot sight according to an embodiment of the present disclosure;

FIG. 10 is a sectional view taken along line B-B shown in FIG. 9;

FIG. 11 is a second side view of the dot sight according to an embodiment of the present disclosure;

FIG. 12 is a sectional view taken along line C-C shown in FIG. 11;

FIG. 13 is a structural schematic diagram of a dot sight according to another embodiment of the present disclosure;

FIG. 14 is a first exploded view of the dot sight according to another embodiment of the present disclosure;

FIG. 15 is a second exploded view of the dot sight according to another embodiment of the present disclosure;

FIG. 16 is a structural schematic diagram of a dot sight according to yet another embodiment of the present disclosure;

FIG. 17 is an exploded view of the dot sight according to yet another embodiment of the present disclosure;

FIG. 18 is a structural schematic diagram of a dot sight according to a further embodiment of the present disclosure;

FIG. 19 is a first exploded view of the dot sight according to the further embodiment of the present disclosure;

FIG. 20 is a second exploded view of the dot sight according to the further embodiment of the present disclosure;

FIG. 21 is a third exploded view of the dot sight according to the further embodiment of the present disclosure;

FIG. 22 is a structural schematic diagram of a dot sight according to still another embodiment of the present disclosure;

FIG. 23 is a structural schematic diagram of a connecting base plate according to an embodiment of the present disclosure;

FIG. 24 is a structural schematic diagram of a connecting base plate according to another embodiment of the present disclosure;

FIG. 25 is a structural schematic diagram of a connecting base plate according to yet another embodiment of the present disclosure; and

FIG. 26 is a structural schematic diagram of a connecting base plate according to a further embodiment of the present disclosure.

### REFERENCE NUMERALS

100. sight; 200. pistol; 300. front sight; 400. rear sight; 500. fastening tool; and 600. mechanical sight channel; and

1. sight body; 11. bottom; 12. side wall; 121. top surface portion; 122. side surface portion; 13. optical channel; 14. fixing structure; 141. locking through hole; 15. access structure; 151. first access hole; 152. second access hole; 16. drain hole; 17. engagement hole; 2. first lens; 3. light source mechanism; 31. light-emitting source; 32. mounting base; 33. ballistic adjustment mechanism; 331. ballistic slider; 332. ballistic driving portion; 3321. ballistic adjusting bolt; 333. first biasing assembly; 3331. first spring; 3332. first biasing member; 334. retaining ring; 34. windage adjustment mechanism; 341. windage slider; 342. windage driving portion; 3421. windage adjusting bolt; 3422. windage adjusting bolt sleeve; 343. second biasing assembly; 3431. second spring; 3432. second biasing member; 3433. biasing fixing member; 4. battery mechanism; 5. sealing member; 6. second lens; 7. power receiving assembly; 8. button assembly; 9. connecting base plate; 91. engagement post; 92. engagement member; 93. threaded hole; 10. sealing ring; and 101. fastener.

### DETAILED DESCRIPTION OF THE EMBODIMENTS

The embodiments of the present disclosure are described below in detail. Examples of the embodiments are shown in the drawings. The same or similar numerals represent the same or similar elements or elements having the same or similar functions throughout the specification. The embodiments described below with reference to the drawings are exemplary, and are intended to explain the present disclosure but should not be construed as a limitation to the present disclosure.

In the description of the present disclosure, it should be understood that orientations or position relationships indicated by terms "length", "width", "upper", "lower", "front", "rear", "left", "right", "vertical", "horizontal", "top", "bottom", "inside", "outside", and the like are based on the orientations or position relationships shown in the drawings. These terms are just used to facilitate the description of the present disclosure and simplify the description, but not to indicate or imply that the mentioned device or elements must have a specific orientation and must be established and operated in a specific orientation, and thus these terms cannot be understood as a limitation to the present disclosure.

In addition, the terms "first" and "second" are merely intended for a purpose of description, and shall not be understood as an indication or implication of relative importance or implicit indication of a quantity of indicated technical features. Thus, features defined with "first" and "second" may explicitly or implicitly include one or more of the features. In the description of the present disclosure, "a plurality of" means two or more, unless otherwise specifically defined.

In the present disclosure, unless otherwise clearly specified, the terms ''installation'', "interconnection", ''connection'' and "fixation" etc. are intended to be understood in a broad sense. For example, the "connection" may be a fixed connection, removable connection or integral connection; may be a mechanical connection or electrical connection; may be a direct connection or indirect connection using a medium; and may be a communication or interaction between two elements. Those of ordinary skill in the art may understand specific meanings of the above terms in the present disclosure based on a specific situation.

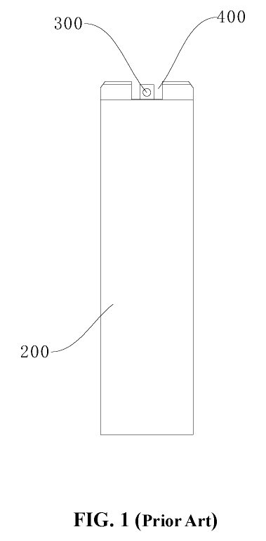

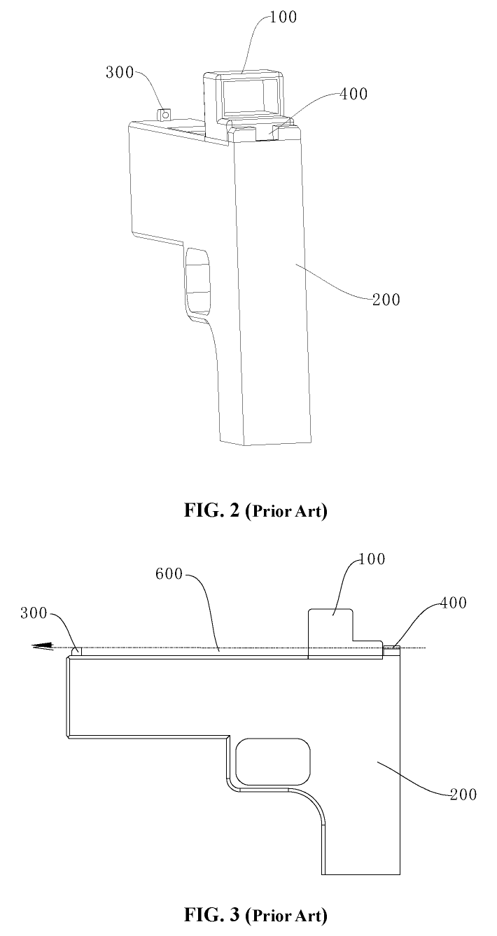

Referring to FIG. 1, in the prior art, a firearm, especially a pistol, can be aimed by aligning the rear sight with the front sight during use. In order to improve the shooting accuracy, a sight can also be mounted on the firearm body for auxiliary aiming. Referring to FIGS. 2 and 3, most existing sights have a relatively thick bottom to ensure mounting stability. Since the sight is generally mounted between the rear sight and the front sight, if the bottom of the sight is higher than the centers of the rear sight and the front sight, it will partially or even completely obstruct the mechanical sight mechanism. In the event of sight failure, damage, or other issues, the firearm cannot be aimed using the mechanical sight mechanism either, significantly impairing the user experience of the firearm. To address the problem that the firearm becomes unable to aim even when the sight fails, adversely affecting the user experience of the firearm, the present disclosure provides a dot sight. The specific solution is as follows:

In order to make the objectives, technical solutions, and advantages of the present disclosure clearer, the present disclosure is described in further detail below with reference to the drawings and embodiments.

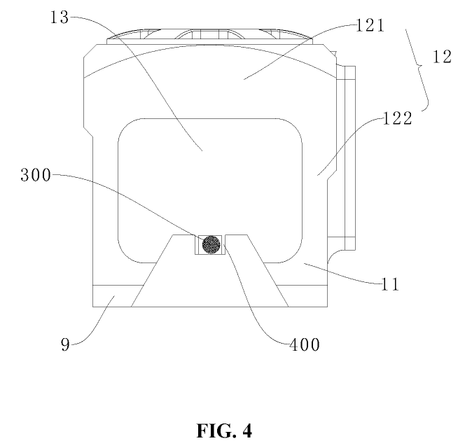

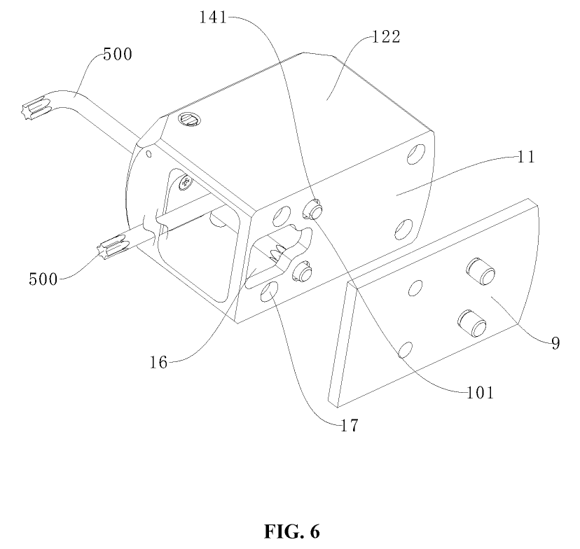

Referring to FIGS. 4 to 12, an embodiment of the present disclosure provides a dot sight. The dot sight includes sight body 1, first lens 2, light source mechanism 3, and battery mechanism 4. The sight body 1 includes bottom 11 and side wall 12. The bottom 11 and the side wall 12 enclose optical channel 13 open at two ends. The first lens 2 is disposed in the optical channel 13. The light source mechanism 3 is disposed on the side wall 12. The light source mechanism 3 is configured to emit light to the first lens 2 to provide an aiming reference for a user. The battery mechanism 4 is disposed on the side wall 12, and the battery mechanism 4 is configured to be electrically connected to the light source mechanism 3 to supply power to the light source mechanism 3. The bottom 11 of the sight body 1 is connected to a firearm body through a fastener. A thickness of the bottom 11 of the sight body 1 is less than or equal to 2.5 mm. The user can observe a front sight through a rear sight and the optical channel 13 after the sight body 1 is mounted.

Specifically, the sight body 1 refers to a shell-shaped component with a certain volume. The sight body 1 is an integrally formed structure, for example, formed by casting, die-casting, machining or other processing methods. Alternatively, the sight body 1 is a split structure formed by a plurality of components connected by welding, fasteners, clamping, or other means. The optical channel 13 refers to a channel structure with a certain length, and the optical channel 13 is disposed along a linear direction for the convenience of light propagation. The bottom 11 and the side wall 12 both refer to structures enclosing the optical channel 13, and the bottom 11 and the side wall 12 may be plate-shaped structures with a certain thickness. The bottom 11 is a flat plate structure for the convenience of connecting it to the firearm body. The side wall 12 refers to other parts of the sight body 1 except the bottom 11. The side wall 12 is composed of a plurality of parts. For example, when a cross section of the sight body 1 is rectangular, the bottom 11 refers to a side wall of the sight body 1 adjacent to the firearm body or connecting base plate 9. In this case, the side wall 12 refers to the sum of the other three side wall surfaces except the bottom 11, and the entire sight body is enclosed by the side wall 12 and the bottom 11 together.

The first lens 2 refers to a structure of the sight body 1 with one or more layers of beam splitting films plated on a concave surface. This design enables the first lens 2 to process and reflect light to form a specific aiming mark for aiming. The first lens 2 is a beam splitter. The light source mechanism 3 refers to a component that can emit light and adjust the starting position of the light, and the light source mechanism 3 can emit light to the first lens 2. The battery mechanism 4 refers to a component that can store and output electric energy, and the battery mechanism 4 can provide electric energy for the operation of the light source mechanism 3. A groove structure is disposed on the side wall 12. When the battery mechanism 4 is mounted, and the battery mechanism 4 is disposed in the groove structure, such that the battery mechanism 4 can be mounted conveniently and firmly.

In the dot sight provided by the embodiment of the present disclosure, the bottom 11 and the side wall 12 of the sight body 1 enclose the optical channel 13, the first lens 2 is disposed in the optical channel 13, and the light source mechanism 3 and the battery mechanism 4 are disposed on the side wall 12 of the sight body 1. The battery mechanism 4 supplies electric energy to the light source mechanism 3, such that the light source mechanism 3 can emit light to irradiate the first lens 2, and the first lens 2 can process and reflect the light to form a specific aiming mark for aiming. Meanwhile, the bottom 11 of the sight body 1 is connected to the firearm body through a fastener, and the thickness of the bottom 11 is less than or equal to 2.5 mm, such that the user can observe the front sight through the rear sight and the optical channel 13 after the sight body 1 is mounted. Compared with the sight in the prior art, during mounting, the bottom 11 of the sight body 1 is connected to the firearm body or the connecting base plate 9, and the light source mechanism 3 and the battery mechanism 4 are disposed on the side wall 12 of the sight body 1 except the bottom 11, such that the bottom 11 can have a small thickness. The thickness of the bottom 11 is less than or equal to 2.5 mm, which is lower than the height of a mechanical sight channel on the firearm. The thickness of the bottom 11 of the sight body 1 is not larger than the height of the centers of the rear sight and the front sight after the sight is mounted, thereby preventing the bottom of the sight from obstructing the mechanical sight mechanism. Thus, after the sight body is mounted, the user can observe the front sight through the rear sight and the optical channel. Thus, even when the sight fails, the shooter can still aim at a target through the mechanical sight mechanism on the firearm body, such that the firearm can still maintain accuracy even when the sight fails, and the secure mounting of the sight is also ensured.

It should be noted that the sight body 1 adopts the above structure in this embodiment, such that when the bottom 11 of the sight body 1 is connected to the connecting base plate 9, the thickness of the bottom 11 of the sight body 1 is less than or equal to 2.5 mm. Thus, the sight does not obstruct the mechanical sight mechanism of the firearm after being mounted, thereby improving the user experience.

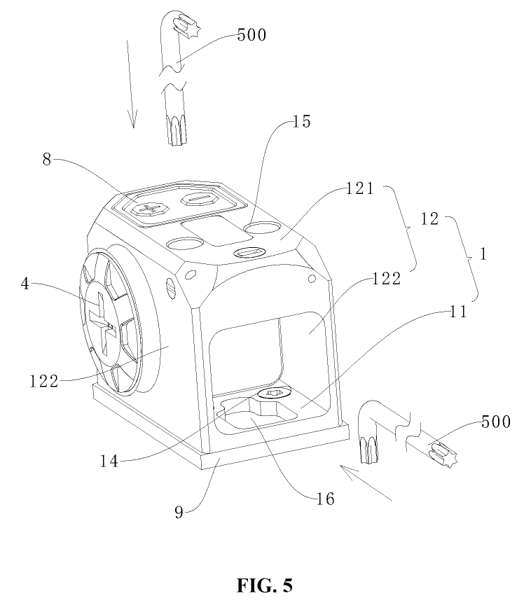

In an optional embodiment, referring to FIGS. 5 to 7, the bottom 11 is provided with fixing structure 14. The fixing structure 14 is configured to allow a fastener to pass through the bottom 11, and the fastener can be completely accommodated inside the fixing structure 14. Specifically, the fixing structure 14 may be locking through hole 141 extending through the bottom 11, and there is a plurality of locking through holes 141. When the sight body 1 is mounted, a fastener such as a locking screw can pass through the locking through hole 141 and be threadedly connected to the firearm body or the connecting base plate 9. A threaded hole engaging with the fastener is disposed in the firearm body or the connecting base plate 9 to realize the fixation and mounting of the sight body 1. The fixing structure 14 enables firm and reliable mounting and fixation of the sight body 1 on the premise of a small thickness of the bottom 11, avoiding the risk that the sight falls off from the firearm body.

In an embodiment, referring to FIGS. 3 to 5, the fastener is a countersunk head screw, and the locking through hole 141 may include a through hole portion for accommodating a main body portion of the countersunk head screw and an accommodating groove portion for accommodating a head portion of the countersunk head screw. Thus, the head portion of the countersunk head screw is completely recessed into the locking through hole 141 after the countersunk head screw is mounted, and the head portion of the countersunk head screw is prevented from protruding out of the bottom 11 to affect aiming.

When the sight body 1 is mounted or dismounted, a fastening tool such as a wrench or a screwdriver can be extended into the optical channel 13 through one opening of the optical channel 13, facilitating the tightening and loosening of the fastener.

In an embodiment, referring to FIGS. 4 to 9, the connecting base plate 9 is disposed between the bottom 11 of the sight body 1 and the firearm body. The connecting base plate 9 is connected to the firearm body through a fastener, and the bottom 11 of the sight body 1 is connected to the connecting base plate 9 and the firearm body through a fastener. Specifically, the connecting base plate 9 refers to a plate-shaped structure with a certain area. The function of the connecting base plate 9 is as follows. When the mounting position of the firearm body is not flat enough, the connecting base plate 9 is mounted on the firearm body, and then the sight body 1 is mounted on the connecting base plate 9. The connecting base plate 9 is mounted on the firearm body by means of fastener fixation. for example, a locking through hole for a fastener to pass through is disposed in the connecting base plate 9, and when the connecting base plate 9 is mounted, the fastener is inserted into the locking through hole and then threadedly connected to the firearm body to realize the mounting and fixation of the connecting base plate 9 on the firearm body. In addition, the connecting base plate 9 is provided with threaded hole 93 for connecting it to the sight body 1, and there is at least one threaded hole 93, such that the sight body 1 can be connected to the connecting base plate 9 through a fastener. When the connecting base plate 9 is disposed between the bottom 11 of the sight body 1 and the firearm body, the thickness of the bottom is 1 mm to 2.5 mm. The height of the bottom of the sight body 1 is still lower than the height of the mechanical sight channel on the firearm after the sight body 1 is mounted in the presence of the connecting base plate 9. Thus, the user can observe the front sight through the rear sight and the optical channel 13, preventing the bottom of the sight from obstructing the mechanical sight mechanism on the firearm.

In an embodiment, referring to FIGS. 5 to 7, the fastener is fixed by a fastening tool. The side wall 12 is provided with access structure 15, and the access structure 15 is configured to provide access for the fastening tool. Specifically, the access structure 15 may refer to a structure disposed on the side wall 12 for a component to pass through the side wall 12 and enter the optical channel 13, and the access structure 15 is a hole structure or a slotted structure, etc. When the sight body 1 is mounted, a fastener such as a locking screw can pass through the locking through hole 141 and then be threadedly connected to the firearm body or the connecting base plate 9. A threaded hole engaging with the fastener is disposed in the firearm body or the connecting base plate 9, such that the sight body 1 is fixed and mounted by the fastener. When the sight body 1 is mounted or dismounted, a fastening tool such as a wrench or a screwdriver can be extended into the optical channel 13 through the access structure 15, such that the fastening tool can contact with the fastener, enabling easy and quick tightening and loosening of the fastener.

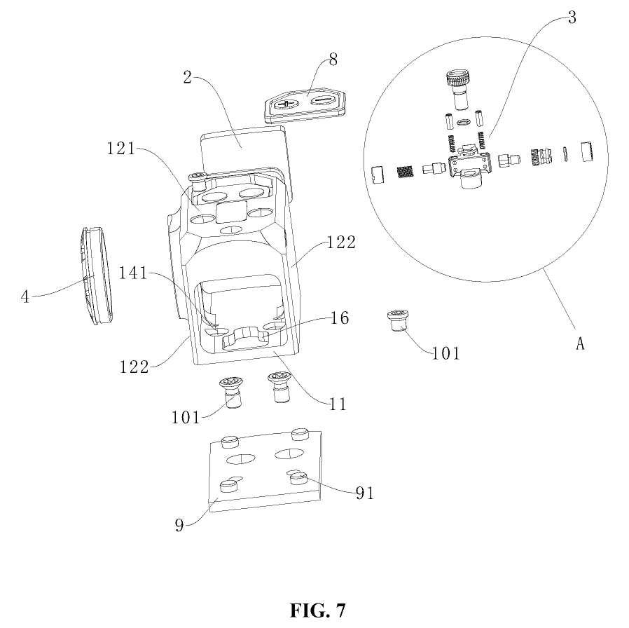

In an embodiment, referring to FIGS. 5 and 7, the side wall 12 includes top surface portion 121 and side surface portion 122. The top surface portion 121 is disposed opposite to and at an interval from the bottom 11. The side surface portion 122 is connected between the top surface portion 121 and the bottom 11. The access structure 15 includes first access hole 151 disposed in the top surface portion 121. A position of the first access hole 151 corresponds to a position of the fastener on the bottom 11.

Specifically, the top surface portion 121 and the side surface portion 122 both refer to plate-shaped structures with a certain area. The top surface portion 121, the side surface portion 122, and the bottom 11 is a split structure, for example, connected by welding, fasteners, clamping or other means. The top surface portion 121, the side surface portion 122, and the bottom 11 may be an integrally formed structure, which is made by stamping, casting, machining or other methods. The first access hole 151 refers to a hole structure disposed in the top surface portion 121, and the first access hole 151 is a circular hole, a square hole, a slotted hole, etc. There is a plurality of first access holes 151, and the number of the first access holes 151 may match the number of the locking through holes 141. By dividing the side wall 12 into the top surface portion 121 and the side surface portion 122, the top surface portion 121 is disposed opposite to and at an interval from the bottom 11, and the side surface portion 122 is connected between the top surface portion 121 and the bottom 11. There may be two side surface portions 122, such that the bottom 11, the top surface portion 121, and the two side surface portions 122 may enclose the rectangular optical channel 13.

The first access hole 151 is disposed in the top surface portion 121 disposed opposite to the bottom 11, and the position of the first access hole 151 corresponds to the position of the fixing structure 14. For example, when the fixing structure 14 adopts the locking through hole 141, an axis of the first access hole 151 and an axis of the locking through hole 141 is located on the same straight line. Thus, a fastening tool such as a wrench or a screwdriver can contact the fastener by moving along a linear direction through the first access hole 151, enabling easy and quick mounting of the sight body 1.

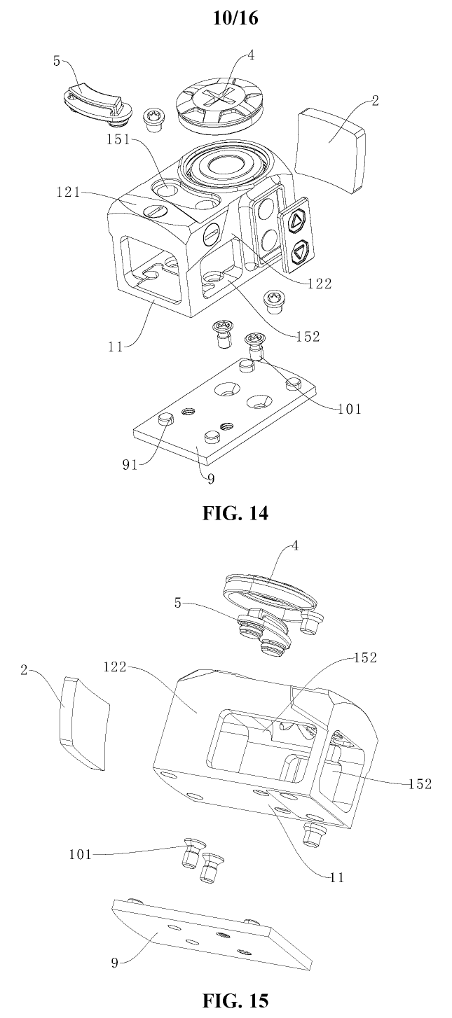

On the basis of the above feature of the first access hole 151, referring to FIGS. 13 to 15, the access structure 15 further includes second access hole 152, and the second access hole 152 is disposed in the side surface portion 122 of the side wall 12. Specifically, the second access hole 152 refers to a hole structure extending through the side surface portion 122, and the second access hole 152 is a circular hole, a square hole, a slotted hole, etc. Since the side surface portion 122 is adjacent to the bottom 11, the second access hole 152 is disposed in the side surface portion 122. When the sight body 1 is mounted, a fastening tool such as a wrench or a screwdriver can be extended into the optical channel 13 through the second access hole 152 to contact with the fastener, such that the fastening tool can contact with the fastener by moving a short path.

In an embodiment, referring to FIGS. 13 to 15, the first access hole 151 is further provided with sealing member 5, and the sealing member 5 is configured to seal the first access hole 151 when the sight body 1 is in operation. Specifically, the sealing member 5 refers to a sealing component with a certain volume, and the sealing member 5 is made of rubber, polyurethane, plastic or other materials. Since the first access hole 151 is disposed in the top surface portion 121 disposed opposite to the bottom 11, the first access hole 151 mostly faces upward during the use of the firearm. Thus, the sealing member 5 is disposed at the first access hole 151, such that the first access hole 151 can be sealed by the sealing member 5 to prevent external rainwater or other moisture from entering the optical channel 13 through the first access hole 151. This keeps the interior of the optical channel 13 dry all the time, thereby ensuring safe use of the sight.

In an optional embodiment, referring to FIGS. 13 and 15, the top surface portion 121 of the side wall 12 is further provided with an accommodating groove, and the first access hole 151 is disposed in a bottom surface of the accommodating groove. The sealing member 5 may include a main body portion and a cylindrical portion. When the sealing member 5 is mounted, the main body portion is mounted in the accommodating groove, and the cylindrical portion is inserted into the first access hole 151. By disposing the accommodating groove on the top surface portion 121 and dividing the sealing member 5 into the main body portion and the cylindrical portion, the contact area between the sealing member 5 and the side wall 12 after mounting is increased, thereby improving the sealing performance of the mounting of the sealing member 5.

In an embodiment, referring to FIGS. 5 to 7, the bottom 11 is provided with drain hole 16, and the drain hole 16 is configured to discharge accumulated water in the optical channel 13 to an exterior of the sight body 1. Specifically, the drain hole 16 refers to a hole structure disposed in the bottom 11, and the drain hole 16 may be in the shape of a circle, a square, or may be a combination of these shapes. The bottom 11 is usually located at the bottom position of the entire sight body 1 when the firearm is in normal operation, and the drain hole 16 is disposed in the bottom 11. Thus, when there is accumulated water in the optical channel 13, the accumulated water can be discharged to the exterior of the optical channel 13 through the drain hole 16, thereby preventing the operation of the sight from being affected by the accumulated water.

In an embodiment, referring to FIG. 15, the side wall 12 includes the top surface portion 121 and the side surface portion 122. The top surface portion 121 is disposed opposite to and at an interval from the bottom 11. The side surface portion 122 is connected between the top surface portion 121 and the bottom 11. The access structure 15 includes the second access hole 152 disposed in the side surface portion 122, and the position of the second access hole 152 is matched with the position of the fastener on the bottom 11.

Specifically, the top surface portion 121 and the side surface portion 122 both refer to plate-shaped structures with a certain area. The top surface portion 121, the side surface portion 122, and the bottom 11 is a split structure, for example, connected by welding, fasteners, clamping or other means. The top surface portion 121, the side surface portion 122, and the bottom 11 may be an integrally formed structure, which is made by stamping, casting, machining or other methods. The second access hole 152 refers to a hole structure extending through the side surface portion 122, and the second access hole 152 is a circular hole, a square hole, a slotted hole, etc. Since the side surface portion 122 is adjacent to the bottom 11, the second access hole 152 is disposed in the side surface portion 122. When the sight body 1 is mounted, a fastening tool such as a wrench or a screwdriver can be extended into the optical channel 13 through the second access hole 152 to contact with the fastener, such that the fastening tool can contact with the fastener by moving a short path. This improves the dismounting and mounting efficiency of the sight.

In an embodiment, referring to FIGS. 7 to 11, the light source mechanism 3 includes light-emitting source 31, mounting base 32, ballistic adjustment mechanism 33, and windage adjustment mechanism 34. The mounting base 32 is movably disposed on the sight body 1. The light-emitting source 31 is disposed on the mounting base 32. The ballistic adjustment mechanism 33 is disposed on the sight body 1, and the ballistic adjustment mechanism 33 is configured to adjust a position of the mounting base 32 along a first direction. The windage adjustment mechanism 34 is disposed on the sight body 1, and the windage adjustment mechanism 34 is configured to adjust a position of the mounting base 32 along a second direction. There is an angle formed between the first direction and the second direction. Specifically, the light-emitting source 31 refers to a component that can convert electric energy into light energy, and the light-emitting source 31 is a light-emitting diode (LED) lamp bead, etc. The mounting base 32 refers to a component with a certain volume. The mounting base 32 may be in the shape of a block, a plate, a post, etc., and the mounting base 32 may be a combination of these shapes. The ballistic adjustment mechanism 33 and the windage adjustment mechanism 34 both refer to components for adjusting the position of a component. The position of the mounting base 32 along the first direction is adjustable through the ballistic adjustment mechanism 33 to realize the adjustment of the position of the light source, such that the aiming mark is adjustable according to the ballistic trajectory. In addition, the position of the mounting base 32 along the second direction is adjustable through the windage adjustment mechanism 34 to realize the adjustment of the position of the light source, such that the aiming mark is adjustable according to the wind speed. The first direction is a vertical direction, and the second direction is a horizontal direction. When the light source mechanism 3 is operating, light can be emitted by the light-emitting source 31 to irradiate the first lens 2, and the first lens 2 can process and reflect the light to form a specific aiming mark for aiming. Meanwhile, the ballistic adjustment mechanism 33 and the windage adjustment mechanism 34 can adjust the positions of the mounting base 32 and the light-emitting source 31, thereby enabling the adjustment of the position of the aiming mark on the first lens 2.

It should be noted that for easy operation of the light source mechanism 3, the mounting base 32 is generally movably disposed on the top surface portion 121 of the side wall 12, and the ballistic adjustment mechanism 33 may also be disposed on the top surface portion 121 of the side wall 12. The windage adjustment mechanism 34 is disposed on the top surface portion 121 of the side wall 12, and the windage adjustment mechanism 34 may also be disposed at a position on the top surface portion 121 of the side wall 12 close to the light-emitting source 31 and the mounting base 32, which will not be repeated herein.

In an optional embodiment, referring to FIGS. 7 to 11, the mounting base 32 is slidably disposed on the side wall 12 of the sight body 1, and an accommodating space for the sliding of the mounting base 32 is disposed on the side wall 12 of the sight body 1. A connecting channel for light transmission is further disposed between the accommodating space and the optical channel 13, which ensures safe and reliable mounting of the light source mechanism 3 and facilitates the light emitted by the light source mechanism 3 to irradiate the first lens 2.

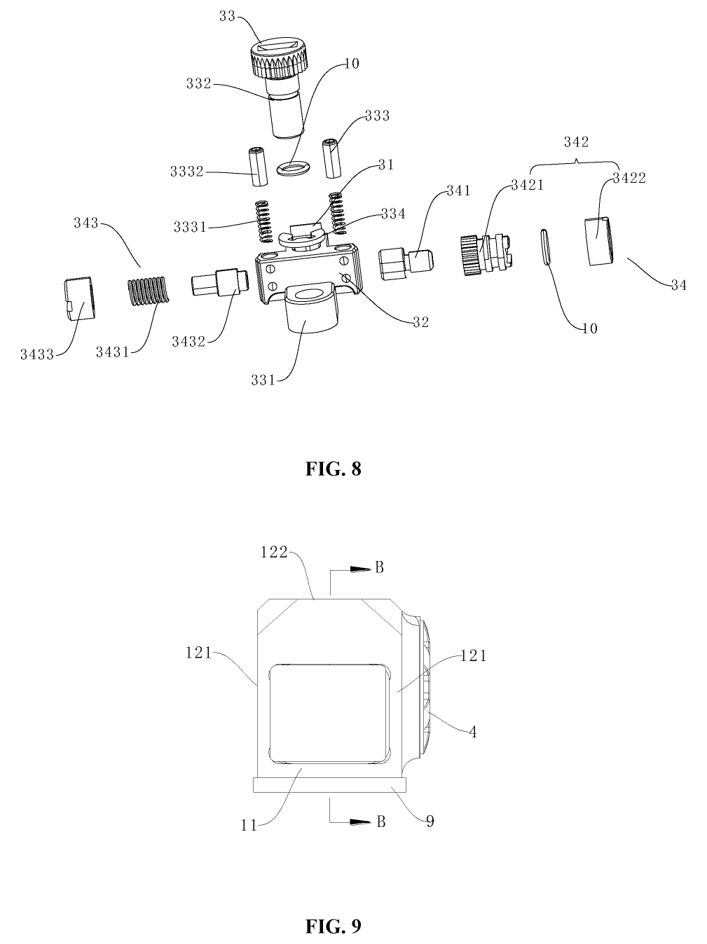

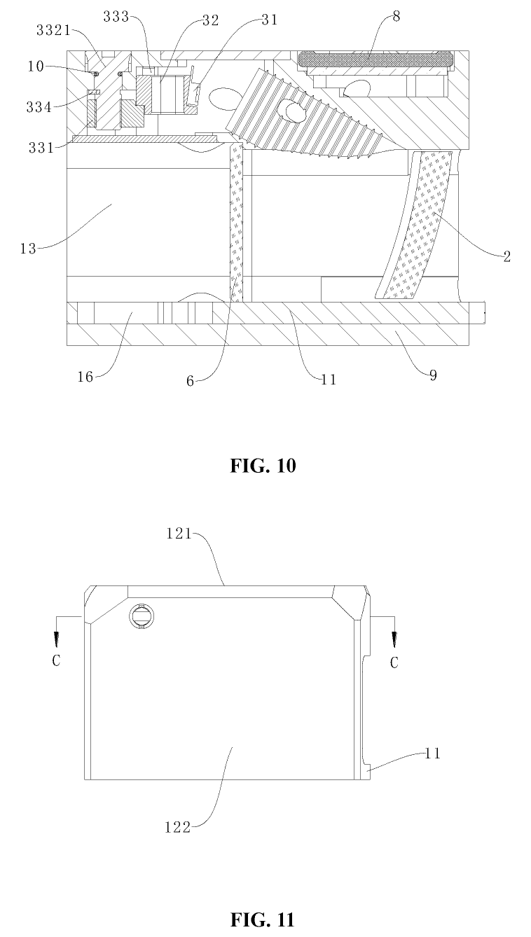

In an embodiment, referring to FIGS. 8 and 10, the ballistic adjustment mechanism 33 includes ballistic slider 331, ballistic driving portion 332, and first biasing assembly 333. The ballistic slider 331 is slidably disposed on the sight body 1, and at least part of the ballistic slider 331 abuts against the mounting base 32. The ballistic driving portion 332 is disposed on the sight body 1, and the ballistic driving portion 332 is configured to drive the ballistic slider 331 to move along the first direction. The first biasing assembly 333 is disposed between the sight body 1 and the mounting base 32, and the first biasing assembly 333 is configured to apply a force to the mounting base 32 toward the ballistic slider 331 such that the mounting base 32 keeps abutting against the ballistic slider 331.

Specifically, the ballistic slider 331 refers to a component with a certain volume. The ballistic slider 331 may be in the shape of a block, a plate, a strip, etc., and the ballistic slider 331 may be a combination of these shapes. The ballistic driving portion 332 refers to a component or assembly that can adjust the position of a component, and the ballistic driving portion 332 is a screw structure, a lever structure, a push block, etc. The first biasing assembly 333 refers to an elastic component or assembly. The first biasing assembly 333 is a spring, a rubber part, an elastic sheet, etc., and the first biasing assembly 333 is a structure formed by a rigid component combined with a spring, a rubber part, an elastic sheet, etc. At least part of the ballistic slider 331 abuts against the mounting base 32, the first biasing assembly 333 is disposed between the sight body 1 and the mounting base 32, and the first biasing assembly 333 is configured to apply a force to the mounting base 32 toward the ballistic slider 331 such that the mounting base 32 keeps abutting against the ballistic slider 331. Thus, the mounting base 32 is prevented from being separated from the ballistic slider 331.

When the position of the mounting base 32 needs to be adjusted, the ballistic slider 331 is driven to move along the first direction by the ballistic driving portion 332. The mounting base 32 moves together with the ballistic slider 331 since at least part of the ballistic slider 331 abuts against the mounting base 32. In addition, the first biasing assembly 333 is disposed between the sight body 1 and the mounting base 32, and a force is applied to the mounting base 32 toward the ballistic slider 331 by the first biasing assembly 333. Thus, the mounting base 32 can still keep abutting against the ballistic slider 331 during movement, thereby facilitating the adjustment of the position of the mounting base 32 along the first direction.

In an embodiment, referring to FIGS. 8 and 10, the ballistic driving portion 332 includes ballistic adjusting bolt 3321. The ballistic adjusting bolt 3321 is rotatably disposed on the sight body 1. An axis of the ballistic adjusting bolt 3321 is disposed along the first direction. The ballistic adjusting bolt 3321 has a degree of freedom to rotate around an axis thereof relative to the sight body 1. At least part of the ballistic adjusting bolt 3321 is threadedly connected to at least part of the ballistic slider 331. Specifically, the ballistic adjusting bolt 3321 refers to a component with a certain length. The ballistic adjusting bolt 3321 is in the shape of a post, a rod, etc., and a cross section of the ballistic adjusting bolt 3321 is circular for easy rotation of the ballistic adjusting bolt 3321. The ballistic adjusting bolt 3321 is provided with an accommodating hole, and at least part of the ballistic slider 331 is inserted into the accommodating hole. The threaded connection is realized via a thread on an outer wall of the part of the ballistic slider 331 inserted into the accommodating hole and a thread on an inner wall of the accommodating hole. Alternatively, an accommodating through hole is disposed in the ballistic slider 331, the ballistic adjusting bolt 3321 is inserted through the accommodating through hole, and the threaded connection is realized via a thread on an outer wall of the ballistic adjusting bolt 3321 and a thread on an inner wall of the accommodating through hole. The ballistic adjusting bolt 3321 has a degree of freedom to rotate around an axis thereof relative to the sight body 1. This can be implemented by retaining ring 334 between the ballistic adjusting bolt 3321 and the sight body 1, and the movement of the ballistic adjusting bolt 3321 along its own axis is limited by the retaining ring 334.

When the position of the ballistic slider 331 needs to be adjusted, the ballistic slider 331 is driven to move along the axis of the ballistic adjusting bolt 3321 only by rotating the ballistic adjusting bolt 3321 around an axis thereof. This allows for easy position adjustment of the ballistic slider 331, thereby enabling easy position adjustment of the mounting base 32 and the light-emitting source 31.

It should be noted that a mounting space for mounting the ballistic adjusting bolt 3321 is disposed on the side wall 12, and at least part of the ballistic adjusting bolt 3321 is located outside the sight body 1 to facilitate the rotation of the ballistic adjusting bolt 3321.

In an embodiment, referring to FIGS. 8 and 10, the first biasing assembly 333 includes first spring 3331 and first biasing member 3332. The mounting base 32 is further provided with a first biasing hole for mounting the first biasing member 3332. A first end of the first biasing member 3332 is movably disposed in the first biasing hole. The first spring 3331 is disposed between the first end of the first biasing member 3332 and a bottom surface of the first biasing hole, and a second end of the first biasing member 3332 slidably abuts against the sight body 1. The first biasing assembly 333 can keep abutting against the sight body 1 without affecting the sliding of the mounting base 32 along the second direction, thereby enabling easy operation of the first biasing assembly 333, and the design of the first biasing hole enables stable mounting of the first biasing assembly 333.

In an optional embodiment, referring to FIGS. 8 and 10, sealing ring 10 may further be disposed between the ballistic adjusting bolt 3321 and the sight body 1, and the sealing ring 10 is sleeved on a periphery of the ballistic adjusting bolt 3321. When retaining ring 334 is provided outside the ballistic adjusting bolt 3321, the sealing ring 10 is located at a position outside the retaining ring 334. Due to the sealing ring 10, when the ballistic adjusting bolt 3321 rotates, the sealing performance of the mounting of the ballistic adjusting bolt 3321 is maintained. This prevents foreign matter from entering the mounting space through the gap between the ballistic adjusting bolt 3321 and the sight body 1, thereby enabling safe operation of the entire sight.

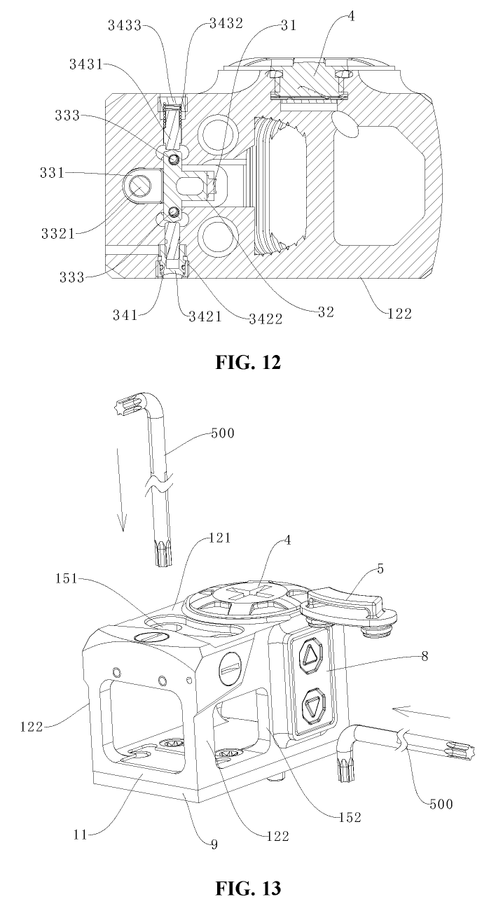

In an embodiment, referring to FIGS. 8 and 12, the windage adjustment mechanism 34 includes windage slider 341, windage driving portion 342, and second biasing assembly 343. The windage slider 341 is slidably disposed on the sight body 1. The windage driving portion 342 is disposed on the sight body 1. The windage driving portion 342 is configured to drive the windage slider 341 to move along the second direction. The second biasing assembly 343 is disposed between the sight body 1 and the mounting base 32. The windage slider 341 and the second biasing assembly 343 respectively abut against two sides of the mounting base 32 along the second direction. The second biasing assembly 343 is configured to apply a force to the mounting base 32 toward the windage slider 341.

Specifically, the windage slider 341 refers to a component with a certain volume. The windage slider 341 may be in the shape of a block, a post, a strip, etc., and the windage slider 341 may be a combination of these shapes. The windage driving portion 342 refers to a component or assembly that can adjust the position of a component, and the windage driving portion 342 is a screw structure, a lever structure, a push block, etc. The second biasing assembly 343 refers to an elastic component or assembly. The second biasing assembly 343 is a spring, a rubber part, an elastic sheet, etc., and the second biasing assembly 343 is a structure formed by a rigid component combined with a spring, a rubber part, an elastic sheet, etc. The windage slider 341 and the second biasing assembly 343 respectively abut against the two sides of the mounting base 32 along the second direction. The windage slider 341 is driven to move along the second direction by the windage driving portion 342, and the second biasing assembly 343 is configured to apply a force to the mounting base 32 toward the windage slider 341 such that the mounting base 32 keeps abutting against the windage slider 341. Thus, when the position of the mounting base 32 needs to be adjusted along the second direction, the windage slider 341 is driven to move along the second direction by the windage driving portion 342, and the mounting base 32 will also move together with the windage slider 341 since the windage slider 341 abuts against the side surface of the mounting base 32. Meanwhile, a force is applied to the mounting base 32 toward the windage slider 341 by the second biasing assembly 343 on the other side of the mounting base 32. Thus, the mounting base 32 can still keep abutting against the windage slider 341 during movement along the second direction. This allows for easy position adjustment of the mounting base 32 along the second direction, thereby enabling easy position adjustment of the light-emitting source 31.

In an optional embodiment, referring to FIGS. 8 and 12, the ballistic slider 331 is provided with two first contact surfaces. An angle is formed between the two first contact surfaces, and the two first contact surfaces are disposed parallel to the second direction. One of the two first contact surfaces is perpendicular to or forms an angle with the first direction. The mounting base 32 is provided with two second contact surfaces for respectively abutting against the two first contact surfaces, and the positions and angles of the two second contact surfaces are matched with those of the first contact surfaces. Through the first contact surfaces on the ballistic slider 331 and the second contact surfaces on the mounting base 32, the ballistic slider 331 drives the mounting base 32 to move along the first direction without affecting the sliding of the mounting base 32 driven by the windage driving portion 342 along the second direction.

In an embodiment, referring to FIGS. 8 and 12, the windage driving portion 342 includes windage adjusting bolt 3421. The windage adjusting bolt 3421 is rotatably disposed on the sight body 1. An axis of the windage adjusting bolt 3421 is disposed along the second direction. The windage adjusting bolt 3421 has a degree of freedom to rotate around an axis thereof relative to the sight body 1, and at least part of the windage adjusting bolt 3421 is threadedly connected to at least part of the windage slider 341. Specifically, the windage adjusting bolt 3421 refers to a component with a certain length. The windage adjusting bolt 3421 is in the shape of a post, a rod, etc., and a cross section of the windage adjusting bolt 3421 is circular for easy rotation of the windage adjusting bolt 3421. The windage adjusting bolt 3421 is provided with an accommodating hole, and at least part of the windage slider 341 is inserted into the accommodating hole. The threaded connection is realized via a thread on an outer wall of the part of the windage slider 341 inserted into the accommodating hole and a thread on an inner wall of the accommodating hole. Alternatively, an accommodating through hole is disposed in the windage slider 341, the windage adjusting bolt 3421 is inserted through the accommodating through hole, and the threaded connection is realized via a thread on an outer wall of the windage adjusting bolt 3421 and a thread on an inner wall of the accommodating through hole. When the position of the windage slider 341 needs to be adjusted, the windage slider 341 is driven to move along the axis of the windage adjusting bolt 3421 only by rotating the windage adjusting bolt 3421 around an axis thereof. This allows for easy position adjustment of the windage slider 341, thereby enabling easy position adjustment of the mounting base 32 and the light-emitting source 31.

It should be noted that a mounting space for mounting the windage adjusting bolt 3421 is disposed on the side wall 12, and at least part of the windage adjusting bolt 3421 is located outside the sight body 1 to facilitate the rotation of the windage adjusting bolt 3421. The mounting space is internally provided with windage adjusting bolt sleeve 3422, and the windage adjusting bolt 3421 sleeve is fixedly disposed in the mounting space. The windage adjusting bolt 3421 is inserted through the windage adjusting bolt 3421 sleeve, and the windage adjusting bolt 3421 sleeve only has a degree of freedom to rotate around an axis thereof relative to the windage adjusting bolt 3421 sleeve. The design of the windage adjusting bolt 3421 sleeve allows for stable and accurate mounting of the windage adjusting bolt 3421 sleeve, thereby enabling accurate adjustment of the windage driving portion 342.

In an embodiment, referring to FIGS. 8 and 12, the second biasing assembly 343 includes second spring 3431, second biasing member 3432, and biasing fixing member 3433. The sight body 1 is further provided with a second biasing hole for accommodating the second biasing member 3432. A first end of the second biasing hole communicates with the accommodating space where the mounting base 32 is located, and a second end of the second biasing hole communicates with the exterior of the sight body 1. During mounting, the second biasing member 3432 is mounted into the second biasing hole from the second end of the second biasing hole. one end of the second biasing member 3432 abuts against a side surface of the mounting base 32, then the biasing fixing member 3433 is disposed at a second end of the second biasing hole, and the second spring 3431 is disposed between the biasing fixing member 3433 and the second biasing member 3432. The second biasing assembly 343 adopts the above structure and is matched with the second biasing hole, thereby enabling easy mounting of the second biasing assembly 343.

In an optional embodiment, referring to FIGS. 8 and 12, the sight body 1 is provided with a windage hole for mounting the windage adjusting bolt 3421. Sealing ring 10 is further disposed between the windage adjusting bolt 3421 and an inner wall of the windage hole. The sealing ring 10 is sleeved on a periphery of the windage adjusting bolt 3421, and its outer periphery abuts against the inner wall of the windage hole. Thus, when the windage adjusting bolt 3421 rotates, the sealing performance of the mounting of the windage adjusting bolt 3421 is maintained. This prevents foreign matter from entering the mounting space through the gap between the windage adjusting bolt 3421 and the sight body 1, thereby enabling safe operation of the entire sight.

In an embodiment, referring to FIG. 10, the dot sight further includes second lens 6, and the second lens 6 is disposed at an interval from the first lens 2 along a length direction of the optical channel 13. Specifically, the second lens 6 refers to a transparent component with a certain thickness, and the second lens 6 is made of glass, acrylic or other materials with excellent light transmittance. By disposing the second lens 6 in the optical channel 13 and disposing the second lens 6 at an interval from the first lens 2 along the length direction of the optical channel 13, the first lens 2 is protected, thereby preventing the operation of the first lens 2 from being affected by rainwater, stains, etc.

In an embodiment, referring to FIG. 10, a periphery of the first lens 2 is hermetically connected to the sight body 1, a periphery of the second lens 6 is also hermetically connected to the sight body 1, and the first lens 2, the second lens 6, and an inner wall surface of at least part of the optical channel 13 enclose a sealed chamber. Specifically, the periphery of the first lens 2 is hermetically connected to the sight body 1, the periphery of the second lens 6 is also hermetically connected to the sight body 1, and the first lens 2, the second lens 6, and the inner wall surface of at least part of the optical channel 13 enclose a sealed chamber. When the sight is in operation, nitrogen or other inert gases can be filled into the sealed chamber to prevent water vapor from entering the space and causing fogging of the first lens 2, thereby improving the shooting accuracy.

In an embodiment, referring to FIG. 10, the connecting base plate 9 is provided with threaded hole 93 engaging with the fastener 101. The threaded hole 93 is located at a side of the second lens 6 away from the first lens 2 and is disposed at an interval from the second lens 6. A minimum distance between an inner wall of the threaded hole 93 and a side surface of the second lens 6 away from the first lens 2 is 2-5 mm. Specifically, during the operation of the sight, the light source mechanism 3 is usually disposed in a top area of an end of the sight body 1 close to an eyepiece side. The light emitted by the light source mechanism 3 passes through a light channel above the sight body and irradiates the first lens 2 at an angle. Then the light is reflected by the first lens 2 and incident to a human eye through the second lens 6. Through the existing assembly tests, on the premise of that the second lens 6 does not obstruct the upper light channel, the position where the fastener 101 connects the sight body 1 and the connecting base plate 9 should be as close to the second lens 6 as possible, so as to ensure that stress balance between the sight body 1 and the connecting base plate 9. In this embodiment, by setting the minimum distance between the inner wall of the threaded hole 93 and the side surface of the second lens 6 away from the first lens 2 to be 2-5 mm, the strength of the connecting base plate 9 and the sight body 1 is ensured on the premise of stress balance between the sight body 1 and the connecting base plate 9, thereby enabling secure mounting of the sight body 1.

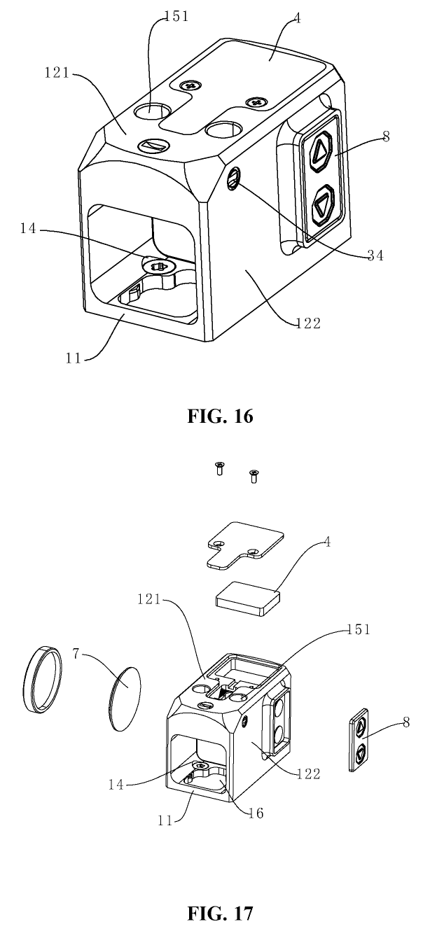

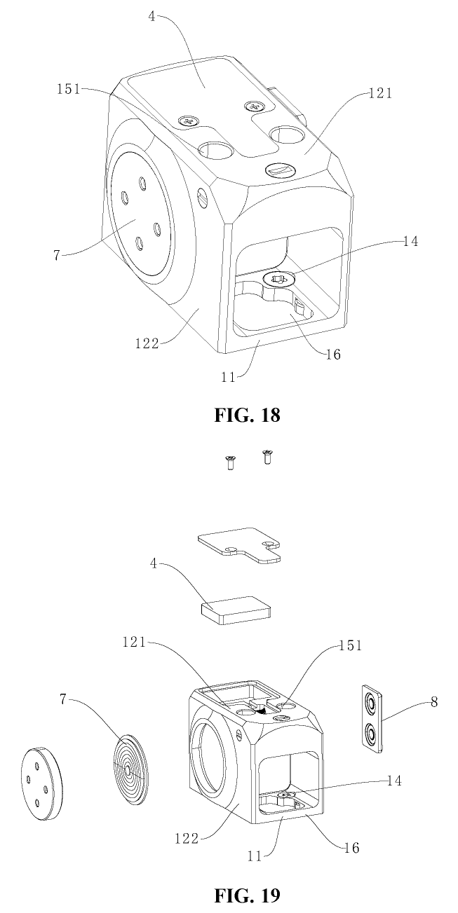

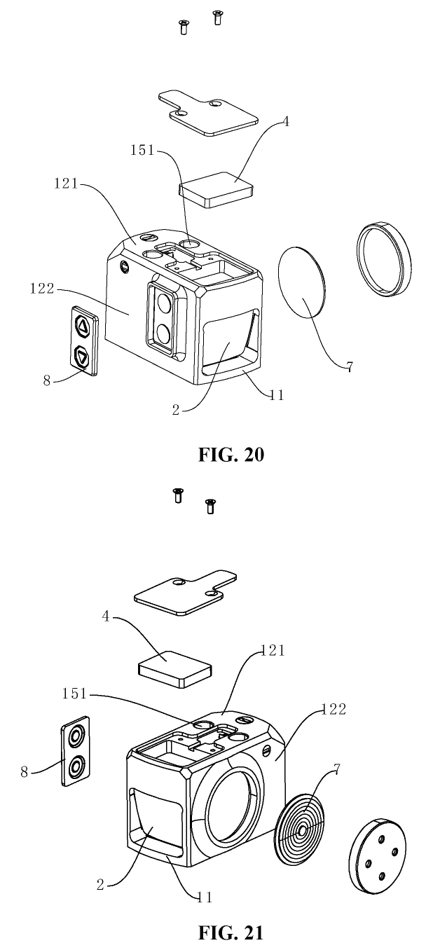

In an embodiment, referring to FIGS. 16 to 21, the side wall 12 is further provided with power receiving assembly 7. The power receiving assembly 7 is electrically connected to the battery mechanism 4, and the power receiving assembly 7 is configured to receive electric energy output by a wireless power supply terminal to charge the battery mechanism 4. Specifically, the power receiving assembly 7 refers to an assembly that can receive the electric energy output by the wireless power supply terminal, and the power receiving assembly 7 may be an induction coil, etc. The power receiving assembly 7 is disposed on the sight body 1, and a wireless charging mode is employed. The power receiving assembly 7 on the sight serves as an energy receiving device, and a portable wireless charging device serves as an energy transmitting device. When the power receiving assembly 7 of the sight is attached to a charging surface of the energy transmitting device, the power receiving assembly 7 receives the electric energy transmitted by the energy transmitting device and transmits the electric energy to the battery mechanism 4 to realize charging, thereby maintaining the normal power supply in the sight.

In an optional embodiment, referring to FIGS. 16 to 21, the power receiving assembly 7 is disposed on one side surface portion 122 of the side wall 12, and the battery mechanism 4 is disposed on the top surface portion 121 of the side wall 12 or on another side surface portion 122 of the side wall 12.

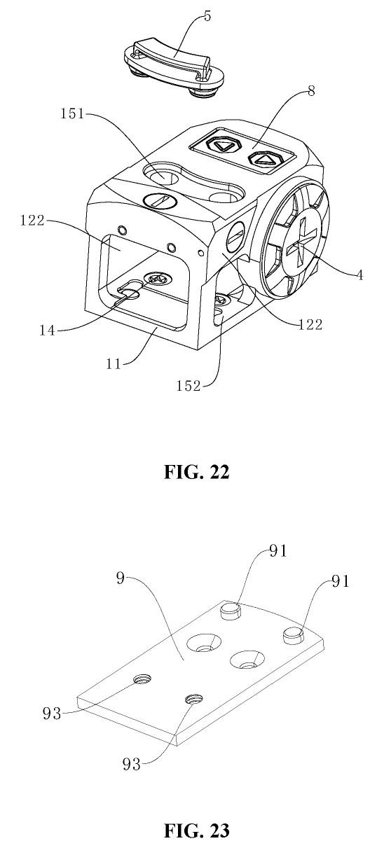

In an embodiment, referring to FIGS. 16 to 21, the side wall 12 of the sight body 1 is further provided with button assembly 8, and the button assembly 8 is configured to adjust the brightness of the light-emitting source 31. Referring to FIG. 22, the button assembly 8 is disposed on the top surface portion 121 of the side wall 12, while the battery mechanism 4 is disposed on the side surface portion 122 of the side wall 12. Referring to FIG. 21, the button assembly 8 is disposed on the side surface portion 122 of the side wall 12, while the battery mechanism 4 is disposed on the top surface portion 121 of the side wall 12, which enables a reasonable external structure layout of the entire sight body 1. It should be noted that, referring to FIG. 21, when the power receiving assembly 7, the button assembly 8, and the battery mechanism 4 are all provided, the battery mechanism 4 is disposed on the top surface portion 121 of the side wall 12, while the button assembly 8 and the power receiving assembly 7 are respectively disposed on the two side surface portions 122 of the side wall 12, thereby enabling reasonable structure layout of the sight body 1.

In an embodiment, referring to FIG. 7, an engagement structure protrudes from a side surface of the connecting base plate 9 in contact with the sight body 1, and engagement hole 17 engaging with the engagement structure is disposed in the bottom 11. The engagement structure is a post, a block, etc. When the sight body 1 and the connecting base plate 9 are fixed to each other, the engagement structure can be inserted into the engagement hole 17 of the bottom 11, thereby enabling secure mounting between the sight body 1 and the connecting base plate 9. Alternatively, engagement post 91 is inserted into the engagement hole 17 to play a positioning role, thereby ensuring the accurate position of the bottom 11 on the connecting base plate 9 and ensuring the accurate position of the sight. In an embodiment, referring to FIG. 23, the engagement structure includes engagement posts 91, and the bottom 11 of the sight body 1 is provided with engagement holes 17 engaging with the engagement posts 91. There are at least two engagement posts 91, and the number of the engagement holes 17 is matched with that of the engagement posts 91. The connecting base plate 9 is provided with at least two threaded holes 93 configured to be connected to the sight body 1. Specifically, the engagement post 91 refers to a cylindrical component with a certain height, and a cross section of the engagement post 91 is usually circular. The engagement post 91 may be integrally formed with the connecting base plate 9. The threaded hole 93 refers to a hole structure with a certain depth, and its inner wall is provided with a thread structure. There are at least two engagement posts 91. The engagement posts 91 are distributed in an area of the connecting base plate 9 close to the first end, or are distributed in an area of the connecting base plate 9 close to the second end. Alternatively, one engagement post is disposed in the area of the connecting base plate 9 close to the first end, while the other engagement post is disposed in the area of the connecting base plate 9 close to the second end. The design is flexible depending on requirements, enabling easy and firm connection between the sight body 1 and the connecting base plate 9.

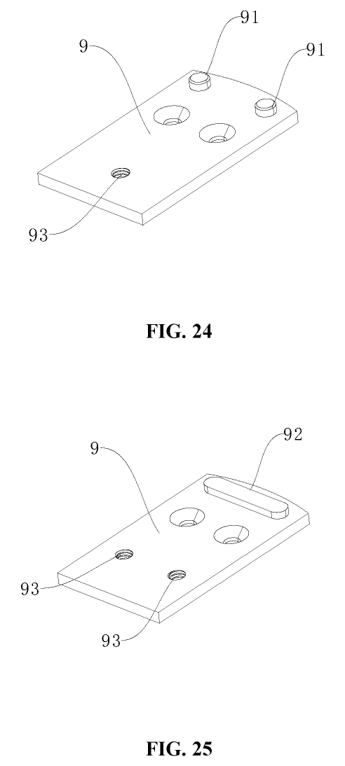

In an embodiment, referring to FIG. 24, the engagement structure includes engagement posts 91, and the bottom 11 of the sight body 1 is provided with engagement holes 17 engaging with the engagement posts 91. There are at least two engagement posts 91, and the number of the engagement holes 17 is matched with that of the engagement posts 91. The connecting base plate 9 is provided with one threaded hole 93 configured to be connected to the sight body 1. The engagement post 91 refers to a cylindrical component with a certain height, and a cross section of the engagement post 91 is usually circular. The engagement post 91 may be integrally formed with the connecting base plate 9. The threaded hole 93 refers to a hole structure with a certain depth, and its inner wall is provided with a thread structure. There are at least two engagement posts 91. The engagement posts 91 are distributed in an area of the connecting base plate 9 close to the first end, or are distributed in an area of the connecting base plate 9 close to the second end. Alternatively, one engagement post is disposed in the area of the connecting base plate 9 close to the first end, while the other engagement post is disposed in the area of the connecting base plate 9 close to the second end. The design is flexible depending on requirements.

In an embodiment, referring to FIG. 25, the engagement structure includes engagement members 92, and the bottom 11 of the sight body 1 is provided with engagement grooves engaging with the engagement members 92. The connecting base plate 9 is provided with at least two threaded holes 93 to be connected to the sight body. Specifically, the engagement member 92 refers to a block-shaped component with a certain height. The shape of the engagement member 92 is not limited here and can be set according to actual conditions. The engagement members 92 can all be integrally formed with the connecting base plate 9. The two engagement members 92 are distributed in the area of the connecting base plate 9 close to the first end or in the area of the connecting base plate 9 close to the second end, which can be flexibly designed according to requirements.

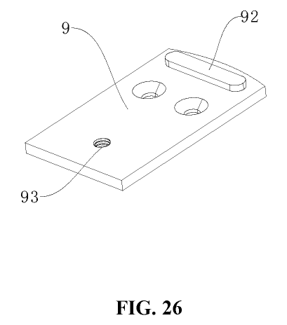

In an embodiment, referring to FIG. 26, the engagement structure includes engagement members 92, and the bottom 11 of the sight body 1 is provided with engagement grooves engaging with the engagement members 92. The connecting base plate 9 is provided with one threaded hole 93 to be connected to the sight body. The engagement member 92 refers to a block-shaped component with a certain height. The shape of the engagement member 92 is not limited here and can be set according to actual conditions. The engagement members 92 can all be integrally formed with the connecting base plate 9. The two engagement members 92 are distributed in the area of the connecting base plate 9 close to the first end or in the area of the connecting base plate 9 close to the second end, which can be flexibly designed according to requirements.

The above described are merely preferred embodiments of the present disclosure, which only specifically sets forth the technical principles of the present disclosure. They are merely intended to explain the principles of the present disclosure, and shall not be construed as a limitation on the scope of protection of the present disclosure in any manner. Based on the explanations herein, all modifications, equivalent substitutions, and improvements made within the spirit and principles of the present disclosure, as well as other specific implementations of the present disclosure that can be conceived of by those skilled in the art without the exertion of creative work, shall all be included within the scope of protection of the present disclosure.

1. A dot sight, comprising: a sight body, a first lens, a light source mechanism, and a battery mechanism, wherein the sight body comprises a bottom and a side wall; the bottom and the side wall enclose an optical channel; the first lens is disposed in the optical channel; the light source mechanism is disposed on the side wall, and is configured to emit light to the first lens to provide an aiming reference for a user; the battery mechanism is disposed on the side wall, and is configured to be electrically connected to the light source mechanism to supply power to the light source mechanism; the bottom of the sight body is connected to a firearm body through a fastener; and a thickness of the bottom is less than or equal to 2.5 mm, allowing the user to observe a front sight through a rear sight and the optical channel after the sight body is mounted.

2. The dot sight according to claim 1, wherein a connecting base plate is disposed between the bottom of the sight body and the firearm body; the connecting base plate is connected to the firearm body through the fastener; and the bottom of the sight body is connected to the connecting base plate and the firearm body through the fastener.

3. The dot sight according to claim 1, wherein the fastener is fixed by a fastening tool; and the side wall is provided with an access structure configured to provide access for the fastening tool.

4. The dot sight according to claim 3, wherein the side wall comprises a top surface portion and a side surface portion; the top surface portion is disposed opposite to and at an interval from the bottom; the side surface portion is connected between the top surface portion and the bottom; the access structure comprises a first access hole disposed in the top surface portion; and a position of the first access hole corresponds to a position of the fastener.

5. The dot sight according to claim 4, wherein the access structure further comprises a second access hole; and the second access hole is disposed in the side surface portion of the side wall.

6. The dot sight according to claim 5, wherein the first access hole is provided with a sealing member; and the sealing member is configured to seal the first access hole when the sight body is in operation.

7. The dot sight according to claim 6, wherein the bottom is provided with a drain hole; and the drain hole is configured to discharge accumulated water in the optical channel to an exterior of the sight body.

8. The dot sight according to claim 3, wherein the side wall comprises a top surface portion and a side surface portion; the top surface portion is disposed opposite to and at an interval from the bottom; the side surface portion is connected between the top surface portion and the bottom; the access structure comprises a second access hole disposed in the side surface portion; and a position of the second access hole is matched with a position of the fastener.

9. The dot sight according to claim 1, wherein the light source mechanism comprises a light-emitting source, a mounting base, a ballistic adjustment mechanism, and a windage adjustment mechanism; the mounting base is movably disposed on the sight body; the light-emitting source is disposed on the mounting base; the ballistic adjustment mechanism is disposed on the sight body, and is configured to adjust a position of the mounting base along a first direction; the windage adjustment mechanism is disposed on the sight body, and is configured to adjust a position of the mounting base along a second direction; and an angle is formed between the first direction and the second direction.

10. The dot sight according to claim 9, wherein the ballistic adjustment mechanism comprises a ballistic slider, a ballistic driving portion, and a first biasing assembly; the ballistic slider is slidably disposed on the sight body; at least part of the ballistic slider abuts against the mounting base; the ballistic driving portion is disposed on the sight body, and is configured to drive the ballistic slider to move along the first direction; the first biasing assembly is disposed between the sight body and the mounting base; and the first biasing assembly is configured to apply a force to the mounting base toward the ballistic slider, wherein the mounting base keeps abutting against the ballistic slider.

11. The dot sight according to claim 10, wherein the ballistic driving portion comprises a ballistic adjusting bolt; the ballistic adjusting bolt is rotatably disposed on the sight body; an axis of the ballistic adjusting bolt is disposed along the first direction; the ballistic adjusting bolt has a degree of freedom to rotate around an axis thereof relative to the sight body; and at least part of the ballistic adjusting bolt is threadedly connected to at least part of the ballistic slider.

12. The dot sight according to claim 9, wherein the windage adjustment mechanism comprises a windage slider, a windage driving portion, and a second biasing assembly; the windage slider is slidably disposed on the sight body; the windage driving portion is disposed on the sight body, and is configured to drive the windage slider to move along the second direction; the second biasing assembly is disposed between the sight body and the mounting base; the windage slider and the second biasing assembly respectively abut against two sides of the mounting base along the second direction; and the second biasing assembly is configured to apply a force to the mounting base toward the windage slider.

13. The dot sight according to claim 12, wherein the windage driving portion comprises a windage adjusting bolt; the windage adjusting bolt is rotatably disposed on the sight body; an axis of the windage adjusting bolt is disposed along the second direction; the windage adjusting bolt has a degree of freedom to rotate around an axis thereof relative to the sight body; and at least part of the windage adjusting bolt is threadedly connected to at least part of the windage slider.

14. The dot sight according to claim 2, wherein the dot sight further comprises a second lens; and the second lens is disposed at an interval from the first lens along a length direction of the optical channel.

15. The dot sight according to claim 14, wherein a periphery of the first lens is hermetically connected to the sight body, and a periphery of the second lens is further hermetically connected to the sight body; and the first lens, the second lens, and an inner wall surface of at least part of the optical channel enclose a sealed chamber.

16. The dot sight according to claim 14, wherein the connecting base plate is provided with a threaded hole engaging with the fastener; the threaded hole is located at a side of the second lens away from the first lens, and is disposed at an interval from the second lens; and a minimum distance between an inner wall of the threaded hole and a side surface of the second lens away from the first lens is 2-5 mm.

17. The dot sight according to claim 1, wherein the side wall is further provided with a power receiving assembly; the power receiving assembly is electrically connected to the battery mechanism; and the power receiving assembly is configured to receive electric energy output by a wireless power supply terminal to charge the battery mechanism.

18. The dot sight according to claim 2, wherein the connecting base plate is provided with an engagement structure; and the engagement structure is configured to position a mounting position of the sight body on the connecting base plate.

19. The dot sight according to claim 18, wherein
the engagement structure comprises engagement posts; the bottom of the sight body is provided with engagement holes engaging with the engagement posts; there are at least two engagement posts; the engagement holes are matched with the engagement posts in quantity; and the connecting base plate is provided with at least two threaded holes configured to be connected to the sight body; or
the engagement structure comprises engagement posts; the bottom of the sight body is provided with engagement holes engaging with the engagement posts; there are at least two engagement posts; the engagement holes are matched with the engagement posts in quantity; and the connecting base plate is provided with one threaded hole configured to be connected to the sight body; or
the engagement structure comprises an engagement member; the bottom of the sight body is provided with an engagement groove engaging with the engagement member; and the connecting base plate is provided with at least two threaded holes configured to be connected to the sight body; or
the engagement structure comprises an engagement member; the bottom of the sight body is provided with an engagement groove engaging with the engagement member; and the connecting base plate is provided with one threaded hole configured to be connected to the sight body.

20. The dot sight according to claim 2, wherein the fastener is fixed by a fastening tool; and the side wall is provided with an access structure configured to provide access for the fastening tool.
